(19) United States
(12) Patent Application Publication
(10) Pub. No.: US 2022/0147921 A1
(43) Pub. Date: May 12, 2022

(54) DELIVERY SUPPORT DEVICE, DELIVERY SYSTEM, AND DELIVERY SUPPORT METHOD

(71) Applicant: TOYOTA JIDOSHA KABUSHIKI KAISHA, Toyota-shi Aichi-ken (JP)

(72) Inventors: Tetsuya Kanata, Toyota-shi Aichi-ken (JP); Masao Tajima, Toyota-shi Aichi-ken (JP); Takashi Hayashi, Toyota-shi Aichi-ken (JP); Nobuyuki Tomatsu, Nagoya-shi Aichi-ken (JP); Hideki Fukudome, Nisshin-shi Aichi-ken (JP); Takashi Hayashi, Nagoya-shi Aichi-ken (JP); Yoshiumi Kawamura, Nisshin-shi Aichi-ken (JP); Kosuke Akatsuka, Mishima-shi Shizuoka-ken (JP); Manabu Yamamoto, Miyoshi-shi Aichi-ken (JP); Kosuke Sakakibara, Toyota-shi Aichi-ken (JP)

(21) Appl. No.: 17/520,073

(22) Filed: Nov. 5, 2021

(30) Foreign Application Priority Data
Nov. 9, 2020 (JP) 2020-186800

(51) Int. Cl. G06Q 10/08; G06Q 10/04; G06Q 50/30

(52) U.S. Cl. CPC G06Q 10/0833; G06Q 50/30; G06Q 10/047

(57) ABSTRACT

The delivery support device includes: a reception destination information acquisition section configured to acquire reception destination information for a package for delivery; a delivery route setting section configured to set a delivery route for a delivery vehicle based on the reception destination information acquired by the reception destination information acquisition section; a delivery acceptance availability determination section configured to acquire a delivery acceptance availability status for a reception destination and determine whether or not it will be possible to hand over the package for delivery based on the delivery acceptance availability status; and a resetting section configured to eliminate the reception destination from the delivery route and reset the delivery route in cases in which the delivery acceptance availability determination section has determined that it will not be possible to hand over the package for delivery.

### CROSS-REFERENCE TO RELATED APPLICATION

This application is based on and claims priority under 35 USC 119 from Japanese Patent Application No. 2020-186800 filed on Nov. 9, 2020, the disclosure of which is incorporated by reference herein.

### BACKGROUND

### Technical Field

The present disclosure relates to a delivery support device, a delivery system, and a delivery support method.

### Related Art

Japanese Patent Application Laid-Open (JP-A) No. 2009-217356 discloses a home delivery arrival time short notice system. When deliveries in a given delivery area have been completed, the home delivery arrival time short notice system predicts a delivery arrival time in the next delivery area, and notifies a delivery recipient of the predicted delivery arrival time by email. In JP-A No. 2009-217356, a delivery route management unit is provided to manage a delivery route in the next delivery area for a delivery driver.

The system disclosed in JP-A No. 2009-217356 enables the recipient to prepare to receive a package by giving the recipient advance notice of the predicted delivery arrival time. However, in cases in which the recipient is not available to receive the package, it is necessary for the driver to adjust the delivery route of their delivery vehicle, leaving room for improvement from the perspective of reducing the burden on the driver.

### SUMMARY

The present disclosure provides a delivery support device, a delivery system, and a delivery support method capable of reducing the burden on a delivery vehicle driver.

A first aspect of the present disclosure is a delivery support device including: a reception destination information acquisition section configured to acquire reception destination information for a package for delivery; a delivery route setting section configured to set a delivery route for a delivery vehicle based on the reception destination information acquired by the reception destination information acquisition section; a delivery acceptance availability determination section configured to acquire a delivery acceptance availability status for a reception destination and determine whether or not it will be possible to hand over the package for delivery based on the delivery acceptance availability status; and a resetting section configured to eliminate the reception destination from the delivery route and reset the delivery route in cases in which the delivery acceptance availability determination section has determined that it will not be possible to hand over the package for delivery.

In the delivery support device of the first aspect, the reception destination information acquisition section acquires the receiving destination information for the package for delivery. The delivery route setting section sets the delivery route for the delivery vehicle based on the receiving destination information. This saves the driver of the delivery vehicle from having to set a delivery route themselves.

Moreover, the delivery acceptance availability determination section acquires the delivery acceptance availability status for a receiving destination and determines whether or not it will be possible to hand over the package for delivery based on the delivery acceptance availability status. In cases in which the delivery acceptance availability determination section has determined that it will not be possible to hand over the package for delivery, the resetting section eliminates the receiving destination of this package for delivery from the delivery route and resets the delivery route. There is accordingly no need for the driver of the delivery vehicle to adjust the delivery route themselves, even in cases in which, for example, a not-at-home notification comes in while en-route to delivery.

A second aspect of the present disclosure, in the first aspect, may further include: a delivery arrival time notification section configured to notify the reception destination of a scheduled delivery arrival time in cases in which a time or distance from a current position of the delivery vehicle to the reception destination on the delivery route set by the delivery route setting section has become a predetermined threshold value or lower; and a delivery acceptance availability reception section configured to receive an unavailable-to-accept-delivery notification for the reception destination, wherein the delivery acceptance availability determination section determines that it will not be possible to hand over the package for delivery in cases in which an unavailable-to-accept-delivery notification has been received by the delivery acceptance availability reception section.

In the delivery support device of the second aspect, the delivery arrival time notification section notifies the reception destination of the scheduled delivery arrival time. The delivery acceptance availability reception section is configured to receive an unavailable-to-accept-delivery notification indicating that the reception destination will not be available to accept delivery. The delivery acceptance availability determination section determines that it will not be possible to hand over the package for delivery in cases in which an unavailable-to-accept-delivery notification has been received by the delivery acceptance availability reception section. In this manner, scheduled delivery arrival time notification, handling of unavailable-to-accept-delivery notifications, and resetting of the delivery route are performed without the involvement of the driver. Note that the “scheduled delivery arrival time” referred to herein is not limited to notification of a timing of scheduled delivery arrival, and includes configurations in which the time remaining until delivery arrival is notified. For example, the “scheduled delivery arrival time” also encompasses indirect notification of the scheduled delivery arrival time, for example in a format such as “Delivery will arrive in the next 10 minutes”.

A third aspect of the present disclosure, in the first aspect or the second aspect, the resetting section may be configured to reset the delivery route so as to prompt a rest break in cases in which a continuous travel time of the delivery vehicle is a predetermined duration or longer and a distance to the next reception destination is a predetermined distance or greater.

In the delivery support device of the third aspect, the resetting section also resets the delivery route in order to prompt a rest break in cases in which the distance to the next receiving destination is large and the delivery vehicle has been traveling without taking a break. This enables the driver to concentrate on driving without needing to pay attention to their rest break timings.

A fourth aspect of the present disclosure, in any one of the first aspect to the third aspect, the delivery route setting section may set the delivery route in consideration of a height of the delivery vehicle so as to use roads navigable by the delivery vehicle.

A fifth aspect of the present disclosure, in the first aspect, may further include a traffic signal information acquisition section configured to acquire traffic signal information including a position of a traffic signal, a current color of the traffic signal, and a time until the traffic signal will next change color, wherein the delivery route setting section and the resetting section set a delivery route based on the acquired traffic signal information so as to enable uninterrupted passage through the traffic signal without stopping.

A six aspect of the present disclosure is a delivery system including: a delivery vehicle configured to deliver a package for delivery, and the delivery support device of any one of the first aspect to the third aspect.

A seventh aspect of the present disclosure is a delivery support method including: acquiring reception destination information for a package for delivery; setting a delivery route for a delivery vehicle based on the reception destination information; acquiring a delivery acceptance availability status for a reception destination; determining whether or not it will be possible to hand over the package for delivery based on the delivery acceptance availability status; and eliminating the reception destination from the delivery route and resetting the delivery route in cases in which determination has been made that it will not be possible to hand over the package for delivery.

The delivery support device, the delivery system, and the delivery support method of the present disclosure are capable of reducing the burden on a delivery vehicle driver.

### BRIEF DESCRIPTION OF THE DRAWINGS

Exemplary embodiments of the present disclosure will be described in detail based on the following figures, wherein:

FIG. 1 is a schematic diagram illustrating an overall configuration of a delivery system including a delivery support device according to a first exemplary embodiment;

FIG. 2 is a block diagram illustrating a hardware configuration of a delivery support device according to the first exemplary embodiment;

FIG. 3 is a block diagram illustrating a functional configuration of a delivery support device according to the first exemplary embodiment;

FIG. 4 is a sequence diagram illustrating an example of a flow of delivery support processing according to the first exemplary embodiment;

FIG. 5 is a flowchart illustrating an example of a flow of delivery support processing according to the first exemplary embodiment; and

FIG. 6 is a block diagram illustrating a functional configuration of a delivery support device according to a second exemplary embodiment.

### DETAILED DESCRIPTION

### First Exemplary Embodiment

Explanation follows regarding a delivery system 10 including a delivery support device 12 according to a first exemplary embodiment, with reference to the drawings.

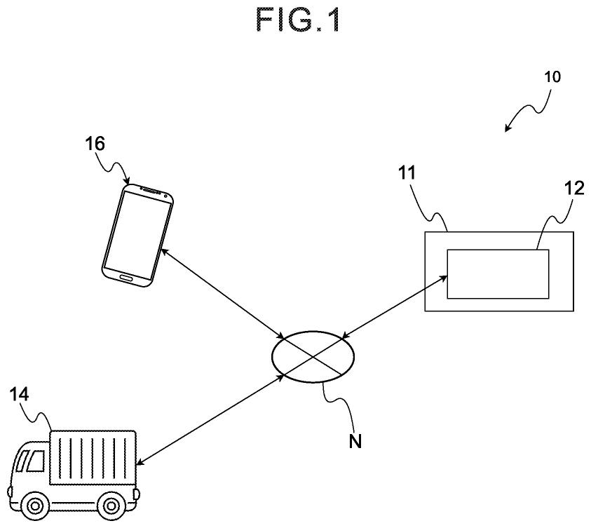

As illustrated in FIG. 1, the delivery system 10 of the present exemplary embodiment includes the delivery support device 12. The delivery support device 12 is provided at a delivery center 11, and is connected to a delivery vehicle 14 and a mobile terminal 16 over a network N. The mobile terminal 16 is a terminal such as a smartphone in the possession of a recipient of a package for delivery.

Hardware Configuration of Delivery Support Device 12

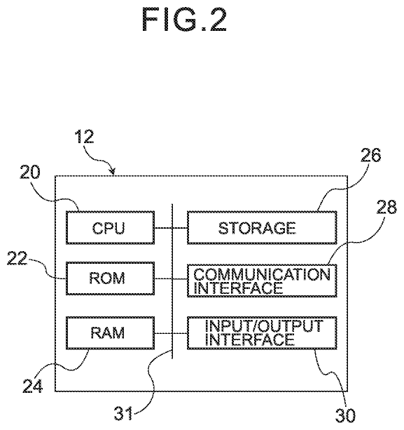

As illustrated in FIG. 2, the delivery support device 12 of the present exemplary embodiment is configured including a central processing unit (CPU) 20 (serving as a processor), read only memory (ROM) 22, random access memory (RAM) 24, storage 26, a communication interface 28, and an input/output interface 30. These configuration elements are connected together so as to be capable of communicating with each other through a bus 31.

The CPU 20 is a central processing unit that executes various programs and controls various sections. Namely, the CPU 20 reads a program from the ROM 22 or the storage 26, and executes the program using the RAM 24 as a workspace. The CPU 20 controls the various configurations and performs various arithmetic processing according to the program recorded in the ROM 22 or the storage 26.

The ROM 22 holds various programs and various data. The RAM 24 serves as a workspace that temporarily stores programs and data. The storage 26 is configured by a hard disk drive (HDD) or a solid state drive (SSD), and is configured by a non-transitory recording medium that holds various programs including an operating system, as well as various data. In the present exemplary embodiment, a program and the like used to execute delivery support processing are held in the ROM 22 or the storage 26.

The communication interface 28 is an interface employed by the delivery support device 12 to communicate over a computer network using a protocol such as 5G, LTE, Wi-Fi (registered trademark), Ethernet (registered trademark), or the like.

Various equipment is connected to the input/output interface 30. For example, a display and the like for displaying computation results may be connected to the input/output interface 30. A keyboard, a mouse, a barcode reader, and the like for performing input to the delivery support device 12 may also be connected to the input/output interface 30.

Functional Configuration of Delivery Support Device 12

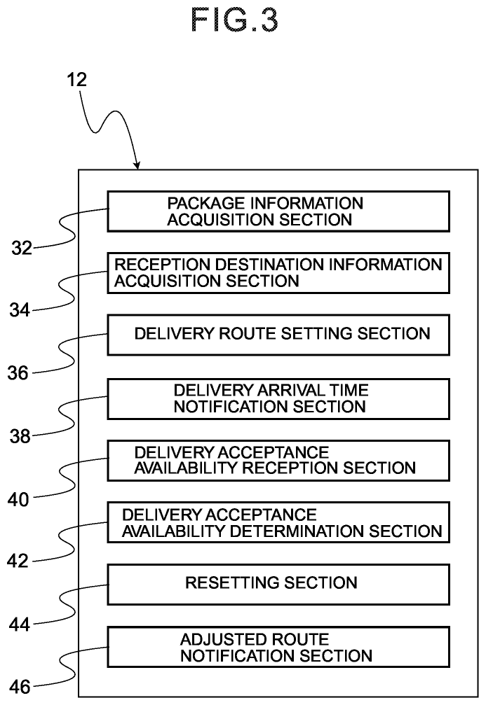

The delivery support device 12 implements various functionality employing the hardware resources described above. Explanation follows regarding functional configuration implemented by the delivery support device 12, with reference to FIG. 3.

As illustrated in FIG. 3, functional configuration of the delivery support device 12 includes a package information acquisition section 32, a reception destination information acquisition section 34, a delivery route setting section 36, a delivery arrival time notification section 38, a delivery acceptance availability reception section 40, a delivery acceptance availability determination section 42, a resetting section 44, and an adjusted route notification section 46. Each of these functional configurations is implemented by the CPU 20 reading and executing the program stored in the ROM 22 or the storage 26.

The package information acquisition section 32 acquires information relating to packages for delivery (referred to hereafter simply as “packages”). As an example, in the present exemplary embodiment, the package information acquisition section 32 acquires information including package sizes and package weights. For example, the package sizes are organized based on combined width direction, depth direction, and height direction dimensions of each package. The package sizes are classified into predetermined size classes according to the combined dimensions, and the appropriate size class is stored together with a package identification number in the storage 26 of the delivery support device 12 or on a server when undertaking delivery of a package. For example, in sequence from smallest to largest, packages may be classified into size classes of S size, M size, L size, and XL size.

The package weights are classified according to predetermined ranges, and a weight class is stored together with the package identification number in the storage 26 of the delivery support device 12 or on a server when undertaking delivery of a package. For example, packages may be classified into weight classes of under 2 kg, under 5 kg, under 10 kg, and under 15 kg.

The package information acquired by the package information acquisition section 32 is managed using radio frequency identifier (RFID) tags or the like. Package information can be acquired by reading the tag accompanying the package. Note that other methods may also be applied for package information management. For example, package information may be managed using barcodes or the like.

The reception destination information acquisition section 34 acquires package receiving destination information. Specifically, the reception destination information acquisition section 34 acquires an address and a name of a delivery arrival destination for each package. In cases in which a preferred delivery arrival date has been registered for the receiving destination, the reception destination information acquisition section 34 also acquires the preferred delivery arrival date. The information acquired by the reception destination information acquisition section 34 may be managed using RFID tags together with the package information.

The delivery route setting section 36 sets a delivery route for the delivery vehicle 14 based on the receiving destination information acquired by the reception destination information acquisition section 34. Specifically, the delivery route setting section 36 sets a delivery route that visits the receiving destination of every package loaded in a cargo bay of the delivery vehicle 14, before returning to the delivery center 11. For example, the delivery route setting section 36 may register the package receiving destinations as waypoints in map data and register the delivery center 11 as a final destination, and then compute a route that passes through each of the waypoints before returning to the delivery center 11. When this is performed, the delivery route setting section 36 sets the delivery route in consideration of the height of the delivery vehicle 14 so as to pass only along roads navigable by the delivery vehicle 14.

The delivery arrival time notification section 38 notifies the receiving destination of a scheduled delivery arrival time. Specifically, the delivery arrival time notification section 38 acquires a current position of the delivery vehicle 14 based on information from a global positioning system (GPS) sensor or the like installed in the delivery vehicle 14. The delivery arrival time notification section 38 then notifies the mobile terminal 16 of the recipient of the scheduled delivery arrival time when a duration or distance from the current position of the delivery vehicle 14 to the receiving destination on the delivery route set by the delivery route setting section 36 has become a predetermined threshold value or lower. For example, the delivery arrival time notification section 38 may send an email notification or the like to the mobile terminal 16 indicating that the delivery will arrive in the next 15 minutes when the remaining time to the receiving destination address as calculated by a navigation system is 15 minutes or less.

The delivery arrival time notification section 38 may also send an email notification or the like to the mobile terminal 16 indicating that the delivery arrival time will be delayed in cases in which, for example, traffic congestion on the delivery route is going to delay the delivery arrival time by 10 minutes or longer.

The delivery acceptance availability reception section 40 is configured to receive an unavailable-to-accept-delivery notification for the receiving destination following notification by the delivery arrival time notification section 38. For example, the text of the email sent to the mobile terminal 16 of the recipient by the delivery arrival time notification section 38 may include guidance regarding what to do in the event that the recipient is not available to receive the package. If the recipient selects a uniform resource locator (URL) provided in the body of the email is cases in which they are unavailable to receive the package, an unavailable-to-accept-delivery signal is transmitted from the mobile terminal 16. In cases in which the delivery acceptance availability reception section 40 receives an unavailable-to-accept-delivery notification from the mobile terminal 16, data corresponding to this unavailability for delivery acceptance is appended to the identification number of the corresponding package.

The delivery acceptance availability reception section 40 may also receive a rescheduled delivery arrival instruction in cases in which the recipient is unavailable to accept the delivery. In such cases, the delivery acceptance availability reception section 40 receives the unavailable-to-accept-delivery notification and a preferred rescheduled delivery arrival time from the mobile terminal 16 and changes the delivery arrival time associated with the identification number of the corresponding package.

The delivery acceptance availability determination section 42 acquires a delivery acceptance availability status for the receiving destination and determines whether or not it will be possible to hand over the package based on this delivery acceptance availability status. Specifically, in cases in which an unavailable-to-accept-delivery notification has been processed by the delivery acceptance availability reception section 40, the delivery acceptance availability determination section 42 determines that it will not be possible to hand over the package associated with this unavailable-to-accept-delivery notification.

In cases in which the delivery acceptance availability determination section 42 has determined that it will not be possible to hand over a package, the resetting section 44 resets the delivery route after eliminating the corresponding receiving destination from the delivery route. To be more specific, firstly, a package that the delivery acceptance availability determination section 42 has determined it will not be possible to hand over is eliminated from the packages for delivery. The resetting section 44 then resets the delivery route so as to visit all receiving destinations of as-yet undelivered packages for delivery, before returning to the delivery center 11.

As an example, the resetting section 44 of the present exemplary embodiment also resets the delivery route to prompt a rest break in cases in which a continuous travel time of the delivery vehicle 14 is a predetermined duration or longer, and the distance to the next receiving destination is a predetermined distance or greater. For example, in cases in which what would have been the next receiving destination has been eliminated from the delivery route by the delivery acceptance availability determination section 42, the delivery route is reset so as to head toward the receiving destination of what was previously scheduled as the second-to-next delivery. When this is performed, in cases in which the distance to this receiving destination is large and the delivery vehicle 14 has been traveling without taking a break, the resetting section 44 registers as a waypoint a location en-route to the next receiving destination where the delivery vehicle 14 is able to park. Such rest break locations may include convenience stores, cafes, and restaurants. The resetting section 44 may also reset the route so as to prompt a rest break in cases in which there is more than enough time remaining until the next delivery arrival time.

The adjusted route notification section 46 notifies the driver of the delivery vehicle 14 when the delivery route has been adjusted. As an example, in the present exemplary embodiment, the adjusted route notification section 46 notifies the driver visually of the adjustment to the delivery route by adjusting the route displayed by the navigation system on a center display of the delivery vehicle 14. Moreover, as an example, in the present exemplary embodiment the driver is also notified by audio when the delivery route has been adjusted.

Operation

Explanation follows regarding operation of the present exemplary embodiment.

Example of Delivery Support Processing

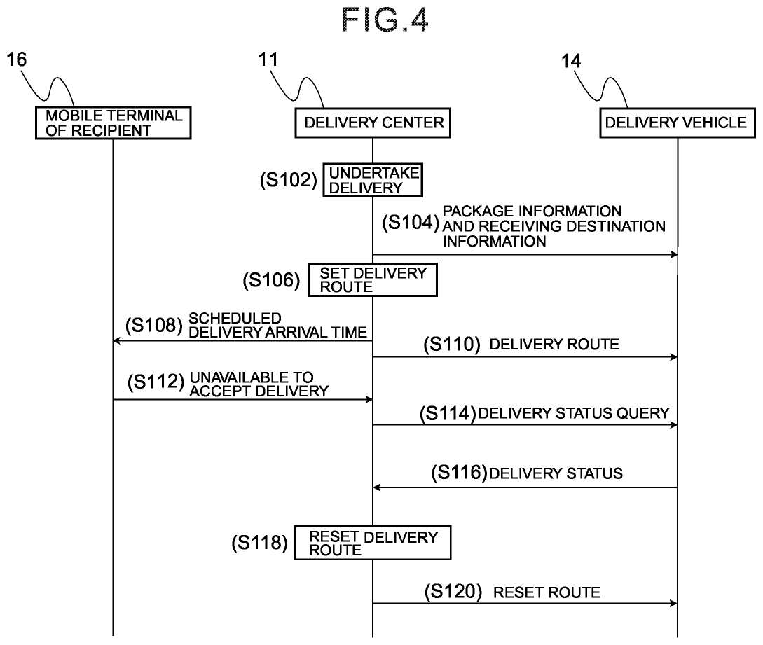

FIG. 4 is a sequence diagram illustrating an example of a flow of delivery support processing by the delivery support device 12. This delivery support processing is implemented by the CPU 20 functioning as the package information acquisition section 32, the reception destination information acquisition section 34, the delivery route setting section 36, the delivery arrival time notification section 38, the delivery acceptance availability reception section 40, the delivery acceptance availability determination section 42, the resetting section 44, and the adjusted route notification section 46. Note that the delivery vehicle 14 discussed in the following explanation is not limited to a system installed in the delivery vehicle 14, and may encompass a terminal or the like in the possession of the driver of the delivery vehicle 14.

At step S102, the delivery center 11 undertakes delivery of a package. When this is performed, information regarding the package is acquired and registered in a database.

At step S104, the delivery center 11 transmits package information and receiving destination information to the delivery vehicle 14. The package information is information such as the number of packages as well as the size and weight of each package. The receiving destination information is information such as position information and a name of the receiving destination.

At step S106, the delivery center 11 sets the delivery route. Specifically, the delivery center 11 utilizes the functionality of the delivery route setting section 36 in order to set the delivery route of the delivery vehicle 14 based on the receiving destination information acquired by the reception destination information acquisition section 34.

At step S108, the delivery center 11 notifies the mobile terminal 16 of the recipient of the scheduled delivery arrival time. Specifically, the delivery center 11 utilizes the functionality of the delivery arrival time notification section 38 in order to notify the mobile terminal 16 of the recipient of the scheduled delivery arrival time when the duration or distance from the current position of the delivery vehicle 14 to the receiving destination has become the predetermined threshold value or lower.

At step S110, the delivery center 11 notifies the delivery vehicle 14 of the delivery route. Specifically, the delivery center 11 registers the delivery route set by the delivery route setting section 36 in the navigation system of the delivery vehicle 14. The delivery center 11 may also notify a terminal in the possession of the driver of the delivery vehicle 14 of the delivery route.

At step S112, a unavailable-to-accept-delivery signal is transmitted from the mobile terminal 16 to the delivery center 11. In other words, at step S112, the delivery center 11 utilizes the functionality of the delivery acceptance availability reception section 40 in order to receive the unavailable-to-accept-delivery communication from the mobile terminal 16.

At step S114, the delivery center 11 queries a delivery status of the delivery vehicle 14, and at step S116, the delivery center 11 receives a delivery status notification from the delivery vehicle 14. Note that the delivery status is a status including a progress status for the delivery route set at step S106. In particular, the delivery center 11 acquires information regarding as-yet undelivered packages from the delivery vehicle 14.

At step S118, the delivery center 11 resets the delivery route. Specifically, the delivery center 11 utilizes the functionality of the resetting section 44 in order to eliminate from the delivery route the receiving destination for which an unavailable-to-accept-delivery notification has been received at step S112, and reset the delivery route so as to visit the receiving destinations of the remaining as-yet undelivered packages, before returning to the delivery center 11.

At step S120, the delivery center 11 notifies the delivery vehicle 14 of the reset route. Specifically, the delivery center 11 utilizes the functionality of the adjusted route notification section 46 in order to adjust the route of the navigation system and notify the driver that the route has been adjusted using audio.

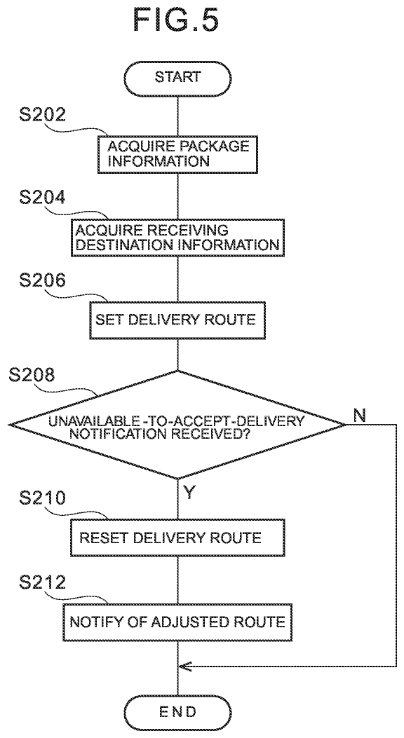

FIG. 5 is a flowchart illustrating an example of a flow of delivery support processing by the delivery support device 12. This delivery support processing is executed by the CPU 20 reading a program from the ROM 22 or the storage 26 and expanding and executing the program in the RAM 24.

At step S202, the CPU 20 utilizes the functionality of the package information acquisition section 32 in order to acquire package information. At step S204, the CPU 20 utilizes the functionality of the reception destination information acquisition section 34 in order to acquire information relating to addresses and names of package delivery arrival destinations, preferred delivery arrival dates, and the like.

At step S206, the CPU 20 utilizes the functionality of the delivery route setting section 36 in order to set a delivery route of the delivery vehicle 14 based on the receiving destination information.

Next, at step S208 the CPU 20 utilizes the functionality of the delivery acceptance availability determination section 42 in order to determine whether or not an unavailable-to-accept-delivery notification has been received. Specifically, in cases in which an unavailable-to-accept-delivery notification has been received for a receiving destination, the CPU 20 utilizes the functionality of the delivery acceptance availability reception section 40 to determine that the unavailable-to-accept-delivery notification has been received, and then transitions to the processing of step S210.

On the other hand, in cases in which no unavailable-to-accept-delivery notification has been received for a receiving destination at step S208, the CPU 20 determines that an unavailable-to-accept-delivery notification has not been received, and ends the delivery support processing.

At step S210, the CPU 20 utilizes the functionality of the resetting section 44 in order to reset the delivery route of the delivery vehicle 14.

Finally, at step S212, the CPU 20 utilizes the functionality of the adjusted route notification section 46 in order to notify the driver of the delivery vehicle 14 of the adjusted route.

As described above, in the present exemplary embodiment, the delivery route setting section 36 sets the delivery route of the delivery vehicle 14 based on the receiving destination information. This saves the driver of the delivery vehicle 14 from having to set a delivery route themselves.

In the present exemplary embodiment, in cases in which the delivery acceptance availability determination section 42 has determined that it will not be possible to hand over a package, the resetting section 44 eliminates the receiving destination of this package from the delivery route and then resets the delivery route. There is accordingly no need for the driver of the delivery vehicle 14 to check for not-at-home notifications, nor for the driver to adjust the delivery route themselves, even in cases in which a not-at-home notification comes in while a package is en-route to delivery. This enables the burden on the driver of the delivery vehicle 14 to be reduced.

Moreover, in the present exemplary embodiment, in cases in which the delivery acceptance availability reception section 40 has received an unavailable-to-accept-delivery notification for a receiving destination, the delivery acceptance availability determination section 42 determines that it will not be possible to hand over the corresponding package. In this manner, scheduled delivery arrival time notification, handling of unavailable-to-accept-delivery notifications, and resetting of the delivery route are performed without the involvement of the driver.

Moreover, in the present exemplary embodiment, the resetting section 44 also resets the delivery route in order to prompt a rest break. This enables the driver to concentrate on driving without needing to pay attention to their rest break timings.

### Second Exemplary Embodiment

Next, explanation follows regarding a delivery support device 52 according to a second exemplary embodiment, with reference to the drawings. Note that configurations similar to those of the first exemplary embodiment are allocated the same reference numerals, and explanation thereof is omitted as appropriate.

Functional Configuration of Delivery Support Device 52

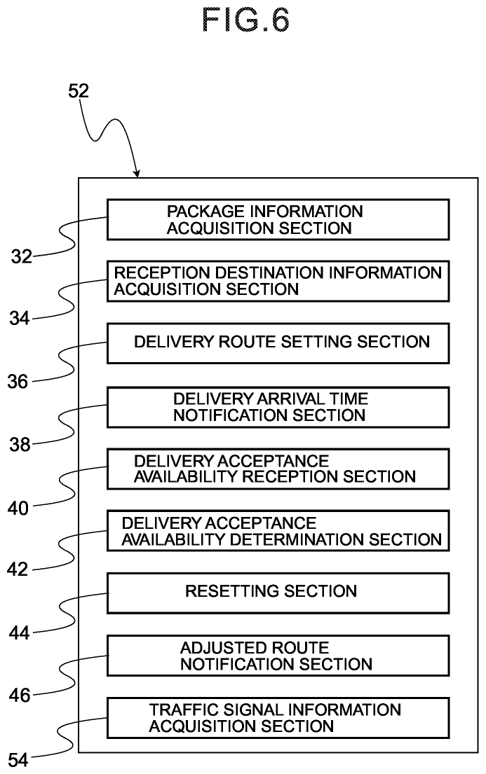

The delivery support device 52 implements various functionality employing the same hardware resources as those in the first exemplary embodiment. Explanation follows regarding functional configurations implemented by the delivery support device 52, with reference to FIG. 6.

As illustrated in FIG. 6, functional configuration of the delivery support device 52 includes the package information acquisition section 32, the reception destination information acquisition section 34, the delivery route setting section 36, the delivery arrival time notification section 38, the delivery acceptance availability reception section 40, the delivery acceptance availability determination section 42, the resetting section 44, the adjusted route notification section 46, and a traffic signal information acquisition section 54. Each of these functional configurations is implemented by the CPU 20 reading and executing a program stored in the ROM 22 or the storage 26. The present exemplary embodiment differs from the first exemplary embodiment in the inclusion of the traffic signal information acquisition section 54.

The traffic signal information acquisition section 54 acquires information regarding traffic signals in a neighborhood where the delivery vehicle 14 is making deliveries. The traffic signal information includes, for example, information regarding the positions of traffic signals, the current color of each traffic signal, and the remaining time until each traffic signal changes color.

Note that the delivery route setting section 36 and the resetting section 44 of the present exemplary embodiment set the delivery route based on the traffic signal information acquired by the traffic signal information acquisition section 54. Specifically, the delivery route setting section 36 first computes a provisional delivery route that visits the receiving destination of every package loaded in the cargo bay of the delivery vehicle 14 before returning to the delivery center 11, and then corrects the provisional delivery route based on the traffic signal information. Namely, an expected arrival timing at each traffic signal on the provisional delivery route is computed, and in cases in which a traffic signal will be red (signifying “stop”) at the expected arrival timing, a diversionary route is found. An optimal delivery route is then set so as to enable uninterrupted passage through traffic signals when they are green (signifying “go”).

Moreover, when the resetting section 44 eliminates from the delivery route a receiving destination for which an unavailable-to-accept-delivery notification has been received and resets the delivery route, the delivery route is reset taking into consideration the traffic signal information acquired by the traffic signal information acquisition section 54.

The resetting section 44 that resets the delivery route may check a travel state of the delivery vehicle 14 periodically. Specifically, virtual representative points may be set at intervals of a predetermined distance on the delivery route, and a predicted passing time computed for each representative point. The timing at which the delivery vehicle 14 passes a representative point is then compared against the predicted passing time in order to determine whether or not the travel state delivery vehicle 14 is consistent with the prediction. In cases in which the travel state of the delivery vehicle 14 is consistent with the prediction, there is no need for the resetting section 44 to reset the route. On the other hand, in cases in which the travel state of the delivery vehicle 14 is running ahead or running behind the prediction, the resetting section 44 may reset the delivery route in consideration of the traffic signal information.

As described above, in the present exemplary embodiment the delivery route of the delivery vehicle 14 is set in consideration of the traffic signal information, thereby enabling the time required for delivery arrival to be reduced. Moreover, since this approach enables delivery arrival times to be computed more precisely, the functionality of the delivery arrival time notification section 38 is capable of notifying of a more precise scheduled delivery arrival time for the receiving destination.

Although explanation has been given regarding the delivery support devices 12, 52 of the first exemplary embodiment and the second exemplary embodiment, obviously a variety of implementations are possible within a range not departing from the spirit of the present disclosure. For example, in the exemplary embodiments described above, in cases in which an unavailable-to-accept-delivery notification has been received by the delivery acceptance availability reception section 40, the delivery acceptance availability determination section 42 determines that it will not be possible to hand over the package corresponding to this unavailable-to-accept-delivery notification. Alternatively, or additionally, another approach may be adopted in order to determine availability for delivery acceptance.

As an example, the delivery acceptance availability determination section 42 may determine unavailability for delivery acceptance in cases in which no acknowledgement is received from a recipient following notification of the mobile terminal 16 of the recipient of the scheduled delivery arrival time by the delivery arrival time notification section 38.

As another example, the delivery acceptance availability determination section 42 may acquire availability information for a drop-off box installed at the receiving destination, and determine unavailability for delivery acceptance in cases in which an unavailable-to-accept-delivery notification has been received for the receiving destination and there is also no drop-off box availability.

As another example, the delivery acceptance availability determination section 42 may determine unavailability for delivery acceptance in cases in which a vehicle belonging to the recipient is not parked in a parking space at the home of the recipient. In such cases, information from a sensor provided at the parking space may be acquired by the delivery center 11 in order to determine whether or not a vehicle is currently parked.

As another example, the delivery acceptance availability determination section 42 may determine unavailability for delivery acceptance based on past history information relating to package acceptance by the recipient. Namely, the delivery acceptance availability determination section 42 may determine unavailability for delivery acceptance in cases in which delivery arrival is scheduled for a time close to a scheduled delivery arrival time at which the recipient has frequently been determined to be unavailable to accept deliveries in the past.

In the exemplary embodiments described above, although explanation has been given regarding configurations in which the delivery support device 12, 52 is provided at the delivery center 11, there is no limitation thereto. For example, the delivery support device 12, 52 may be provided in the delivery vehicle 14. In such cases, communication can be performed between the delivery vehicle 14 and the mobile terminal 16 directly.

Note that the processing executed by the CPU 20 reading and executing software (a program) in the above exemplary embodiments may be executed by various types of processor other than the CPU 20. Examples of such processors include programmable logic devices (PLD) that allow circuit configuration to be modified post-manufacture, such as a field-programmable gate array (FPGA), and dedicated electric circuits configured by processors including a circuit configuration custom-designed to execute specific processing, such as an application specific integrated circuit (ASIC). The delivery support processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Moreover, in the exemplary embodiments described above, although the storage 26 is employed as a recording section, there is no limitation thereto. For example, a non-transitory recording medium such as a compact disc (CD), digital versatile disc (DVD), or universal serial bus (USB) memory may be employed as a recording section. In such cases, the various programs may be held in such recording media.

What is claimed is:

1. A delivery support device, comprising a processor, wherein the processor is configured to:
acquire reception destination information for a package for delivery;
set a delivery route for a delivery vehicle based on the reception destination information;
acquire a delivery acceptance availability status for a reception destination;
determine whether or not it will be possible to hand over the package for delivery based on the delivery acceptance availability status; and
eliminate the reception destination from the delivery route and reset the delivery route in cases in which determination has been made that it will not be possible to hand over the package for delivery.

2. The delivery support device of claim 1, wherein the processor is further configured to:
notify the reception destination of a scheduled delivery arrival time in cases in which a time or distance from a current position of the delivery vehicle to the reception destination on the delivery route has become a predetermined threshold value or lower; and
determine that it will not be possible to hand over the package for delivery in cases in which an unavailable-to-accept-delivery notification has been received for the reception destination.

3. The delivery support device of claim 1, wherein the processor is further configured to reset the delivery route so as to prompt a rest break in cases in which a continuous travel time of the delivery vehicle is a predetermined duration or longer and a distance to a next reception destination is a predetermined distance or greater.

4. The delivery support device of claim 1, wherein the processor is further configured to set the delivery route in consideration of a height of the delivery vehicle so as to use roads navigable by the delivery vehicle.

5. The delivery support device of claim 1, wherein the processor is further configured to:
acquire traffic signal information including a position of a traffic signal, a current color of the traffic signal, and a time until the traffic signal will next change color; and
set a delivery route based on the traffic signal information so as to enable uninterrupted passage through the traffic signal without stopping.

6. A delivery system, comprising:
a delivery vehicle configured to deliver a package for delivery; and
the delivery support device of claim 1.

7. A delivery support method for a processor, the method comprising:
acquiring reception destination information for a package for delivery;
setting a delivery route for a delivery vehicle based on the reception destination information;
acquiring a delivery acceptance availability status for a reception destination;
determining whether or not it will be possible to hand over the package for delivery based on the delivery acceptance availability status; and
eliminating the reception destination from the delivery route and resetting the delivery route in cases in which determination has been made that it will not be possible to hand over the package for delivery.
